(19) United States
(12) Patent Application Publication
(10) Pub. No.: US 2007/0010767 A1
(43) Pub. Date: Jan. 11, 2007

(54) Multidirectional oscillating device for a massage device

(75) Inventor: Wen Hsu Hsieh, Chang-Hua City (TW)

Correspondence Address: CHARLES E. BAXLEY, ESQ., 90 JOHN STREET, THIRD FLOOR, NEW YORK, NY, 10038, US

(73) Assignee: Kuang Yu Metal Working Co., Ltd.

(21) Appl. No.: 11/177,158

(22) Filed: Jul. 7, 2005

(51) Int. Cl. A61H 19/00; A61H 7/00

(52) U.S. Cl. 601/96

(57) ABSTRACT

A multidirectional oscillating structure for a massage device comprises a slide seat, a slide block, a pivot, an oscillating board and an airbag. On the slide seat is provided a rail on which the slide block is moveably disposed, the oscillating board is vertically pivoted to the slide block, and the airbag will push the oscillating board to carry out a massage treatment to the user in response to user's body curve. The oscillating board can move freely from horizontal to vertical direction, so as to do massage more accurately in response to the real curve of different user's legs, carrying out a more comfortable massage effect.

### BACKGROUND OF THE INVENTION

1. Field of the Invention

The present invention relates to a massage device, and more particularly to a multidirectional oscillating device that can carry out massage treatment in response to real contour of a user's body.

2. Description of the Prior Art

Most of the existing massage devices use a pair of opposite shaft-driven massaging members to carry out a unidirectional massage action with unchangeable massage strength and angle. However, this unchangeable monotonous massage mode has lost its appeal to the consumers.

Therefore, another massage device with adjustable massage angle and force started to appear on the market, as shown in FIG. 1, which is a massage device disclosed by JP Pt. No. 2004-16501A and comprises a mounting base 10, a massage board 11 pivoted to either side of the mounting base 10 via a pivot 12, and an airbag 13 used to push the backside of the massage boards 11. The pivot 12 is able to adjust the massage angle of the massage boards 11 in response to the curve of a user's body, and the massage force of the airbag 13 also can be adjusted by an air adjustment system. However, this type massage device still has some defects that need to be improved:

First, the massage angle of the massage boards 11 can be adjusted by the airbag 13, however, the rotating direction of the massage boards 11 is unchangeable once it is fixed.

Second, the massage boards 11 are only able to massage both sides of the leg, therefore, this type massage device is monotonic in massage mode.

Third, legs of different users are different in shape and size, however, the massage boards 11 are fixed to the mounting base 10 by the pivot 12, it may lead to such a result that a thin leg may feel too loose or even can't feel the pressure from the massage boards 11, while a big leg will feel too tight and even have the risk of injury caused by an excessive strong pressure. Furthermore, the service life of the massage device will also be adversely affected.

The present invention has arisen to mitigate and/or obviate the afore-described disadvantages.

### SUMMARY OF THE INVENTION

The primary objective of the present invention is to provide a multidirectional oscillating device that can do massage in response to real contour of a user's body through inflation and deflation of an airbag, and the oscillating board is horizontally rotatable and moveable such that it can change oscillation angle in response to the contour of the user's leg (the left and right oscillating boards can move asymmetrically). The degree of the inflation and deflation of the airbag also is under the control of the user. Therefore, the device of the present invention is able to adjust the massage effect according to the size of the user's leg, imitating a real professional massage operation.

The secondary objective of the present invention is to provide a multidirectional oscillating device that fits different users. With the slide block and the airbag, the massage board can be adjusted automatically to fit different sizes of legs, thus overcoming the too loose or too tight massage problem of the conventional massage device.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an illustrative view of a conventional massage device;

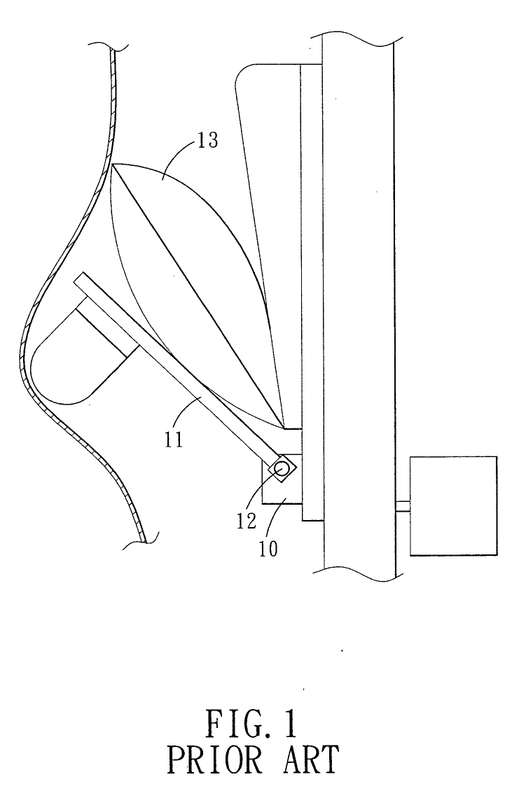

FIG. 2 is a perspective view of a multidirectional oscillating device in accordance with an embodiment of the present invention;

FIG. 3 is an illustrative view of the multidirectional oscillating device in accordance with the embodiment of the present invention, wherein the airbag is deflated;

FIG. 4 is an illustrative view of the multidirectional oscillating device in accordance with the embodiment of the present invention, wherein the airbag is inflated;

FIG. 5 is a side view of the multidirectional oscillating device in accordance with the embodiment of the present invention;

FIG. 6 is another side view of the multidirectional oscillating device in accordance with the embodiment of the present invention;

FIG. 7 is an operational view of the multidirectional oscillating device in accordance with the embodiment of the present invention;

FIG. 8 shows that the multidirectional oscillating device in accordance with the present invention is assembled to a massage chair.

### DETAILED DESCRIPTION OF THE PREFERRED EMBODIMENT

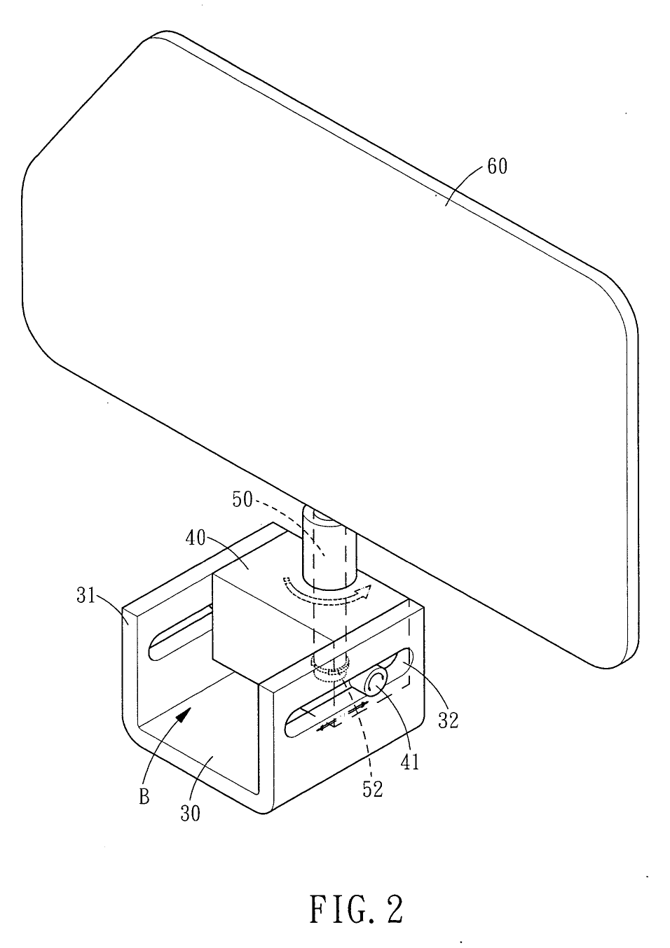

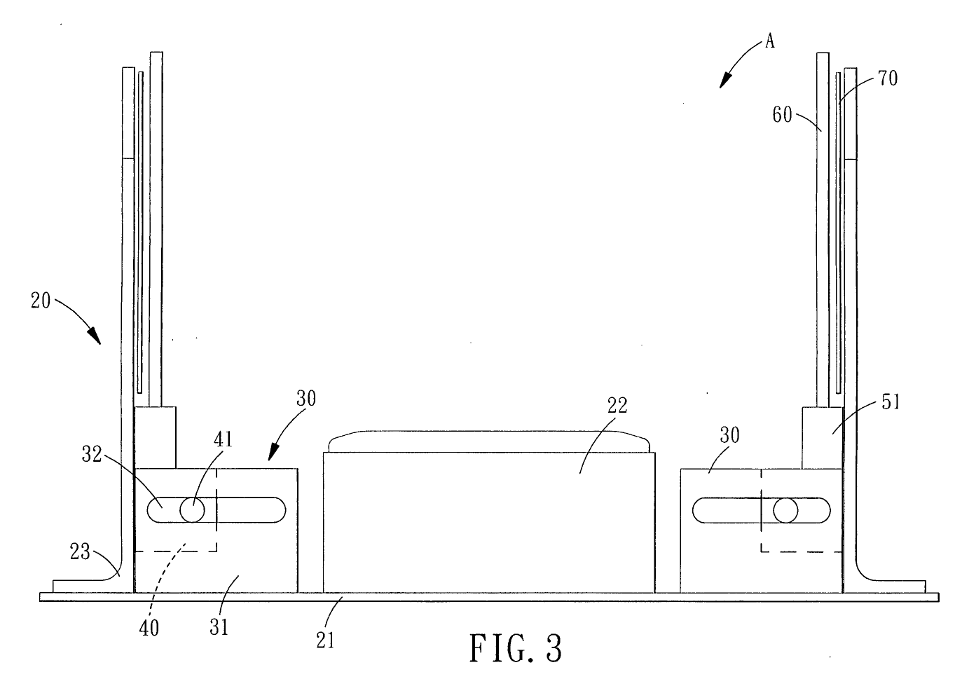

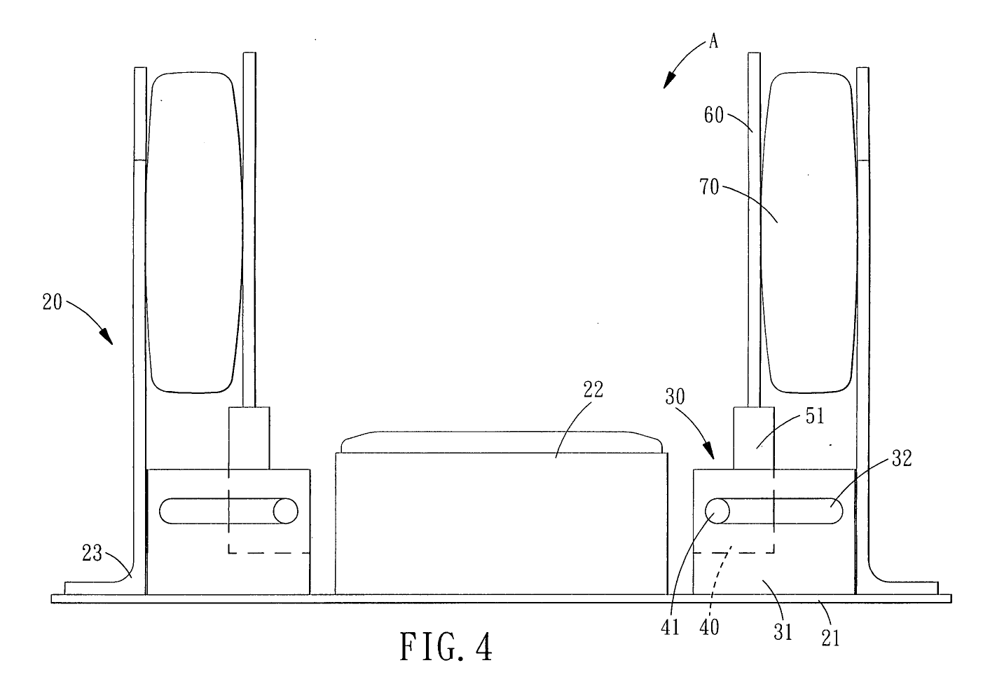

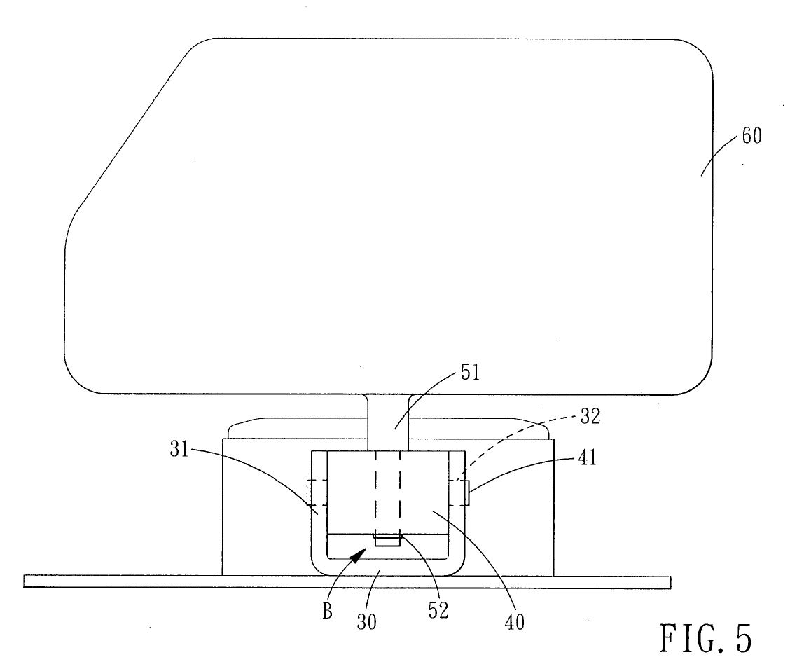

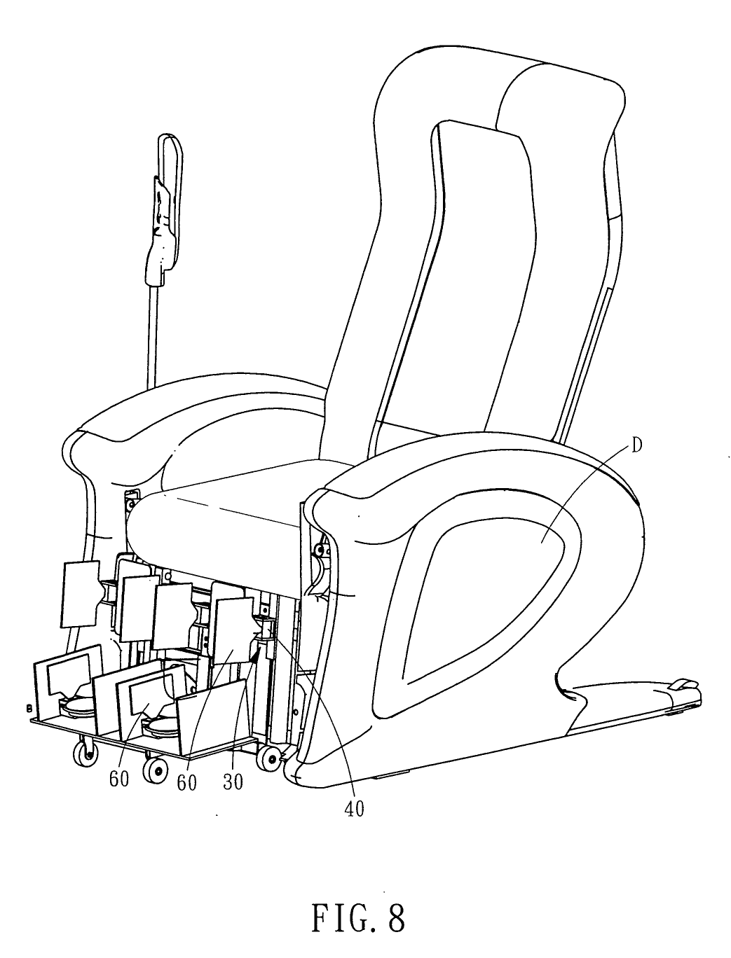

Referring to FIGS. 2-5 and 8, a plurality multidirectional oscillating devices in accordance with an embodiment of the present invention are arranged in pairs in a footrest 20 of a massage chair D. The footrest 20 includes a base 21, two oscillating members 22 (such as an oscillating horn) and a plurality of supporting members 23. The base 21, the oscillating members 22 and the plurality of supporting members 23 define a space A. Each of the multidirectional oscillating devices comprises a slide seat 30, a slide block 40, a pivot 50, an oscillating board 60 and an airbag 70.

The slide seat 30 is disposed at either side of the respective supporting members 23 of the footrest 20 and comprises a pair of positioning pieces 31 arranged in the direction of the space A. Between the pair of positioning pieces 31 is defined a space B, and on each of the pair of positioning pieces 31 is correspondingly formed a horizontal slot 32 (equivalent to a slide rail).

The slide block 40 is provided at either side thereof with a slide shaft 41 to be inserted in the slots 32 of the slide seat 30, such that the slide block 40 is moveably positioned in the space B of the slide seat 30 and is rotatable relative to the horizontal axis of the slide seat. On the slide block 40 is further defined with a vertically extending hole 42.

The pivot 50 is rotatably positioned in the hole 42 of the slide block 40 by a sleeve 51 and a retainer 52.

The oscillating board 60 is fixed at the end of the pivot 50 and located in the space A.

The airbag 70 is arranged between the oscillating board 60 and the respective supporting members 23 of the footrest 20, and is provided with air tubes through which the airbag 70 can be inflated and deflated under the control of the user.

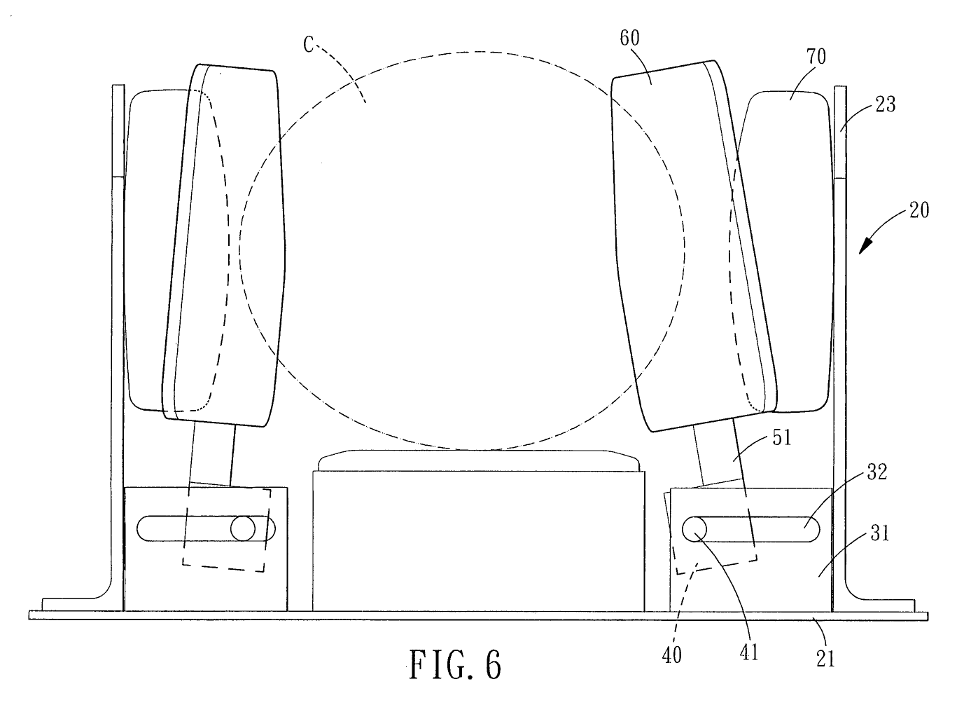

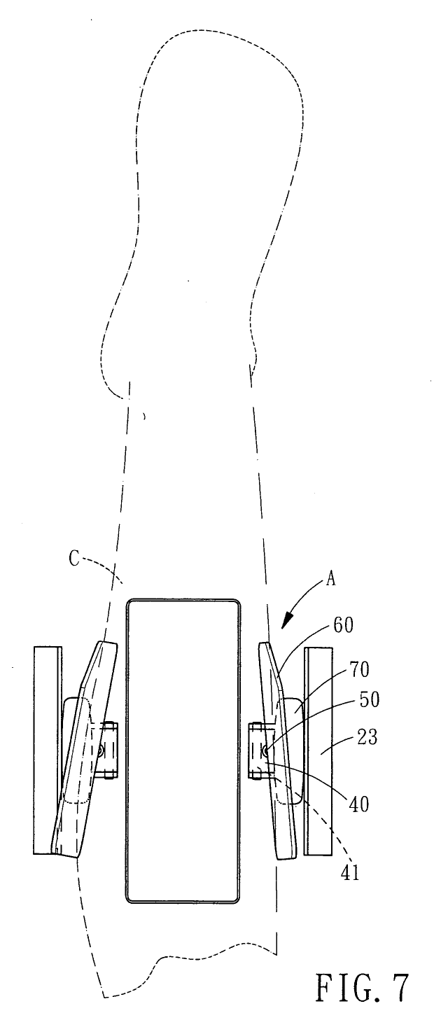

For a better understanding of the present invention, its operations and functions, references should be made to FIGS. 6-8. Since the airbag 70 is arranged between the oscillating boards 60 and the respective supporting members 23 of the footrest 20, it will push the oscillating board 60 evenly against the leg C of the user. Due to the two sides of the leg C have different contours, the left and right massage boards 60 will oscillate asymmetrically. Furthermore, the slide block 40 allows the massage board 60 to move and rotate horizontally, while the pivot 50 is able to pivot vertically with respect to the slide block 40, therefore, the left and right massage boards 60 are able to massage more accurately in response to the real contour of the leg C of the user. Plus the inflation and deflation of the airbag 70 will provide a wave-like massage treatment to the user. Therefore, the massage device of the present invention can truly provide a real professional massage effect by pressing the massage boards 60 substantially against the real contour of the user's leg.

It will be noted that with the slide block 40 and the airbag 70, the massage board 60 can be adjusted automatically to fit different sizes of legs, thus imitating a real professional massage operation, and overcoming the too loose or too tight massage problem of the conventional massage device.

The aforementioned massage effect of the present invention is obtained mainly because of the following structure:

First, the slide block 40 allows the massage board 60 to move and rotate horizontally.

Second, the pivot 50 is able to pivot vertically with respect to the slide block 40.

While we have shown and described various embodiments in accordance with the present invention, it should be clear to those skilled in the art that further embodiments may be made without departing from the scope of the present invention.

What is claimed is:

1. A multidirectional oscillating device for a massage device comprising:
an oscillating board pivoted to a slide block and employed to carry out massage treatment in response to real contour of a user's body through inflation and deflation of an airbag, the slide block being moveably positioned on a horizontal slide rail of a slide seat in a pivotal manner.

2. The multidirectional oscillating device for a massage device as claimed in claim 1, further comprising a slide seat, a slide block, a pivot, the oscillating board and an airbag, wherein the oscillating board is vertically pivoted to the slide block through the pivot, the airbag drives the oscillating board to press against the user's body, so as to carry out a massage treatment in response to real contour of the user's body.

3. The multidirectional oscillating device for a massage device as claimed in claim 2, wherein the massage device is a footrest that has a space A for accommodation of the user's leg.

4. The multidirectional oscillating device for a massage device as claimed in claim 1, wherein the massage device includes a base, two oscillating members and a plurality of supporting members, the base, the oscillating members and the plurality of supporting members define the space A.

5. The multidirectional oscillating device for a massage device as claimed in claim 2, wherein the massage device includes a base, two oscillating members and a plurality of supporting members, the base, the oscillating members and the plurality of supporting members define the space A.

6. The multidirectional oscillating device for a massage device as claimed in claim 4, wherein
the slide seat is disposed at either side of the respective supporting members of the footrest and comprises a pair of positioning pieces arranged in a direction of the space A, between the pair of positioning pieces is defined a space B, and on each of the pair of positioning pieces is correspondingly formed a horizontal slot;
the slide block is provided at either side thereof with a slide shaft to be inserted in the slot of the slide seat, such that the slide block is moveably positioned in the space B of the slide seat and is rotatable relative to a horizontal axis of the slide seat, on the slide block is further defined with a vertically extending hole;
the pivot is rotatably positioned in the hole of the slide block;
the oscillating board is fixed at the end of the pivot and located in the space A; and
the airbag is arranged between the oscillating board and the respective supporting members of the footrest, and is provided with air tubes through which the airbag will be inflated and deflated under the control of the user.

7. The multidirectional oscillating device for a massage device as claimed in claim 5, wherein the pivot is rotatably positioned in the hole of the slide block by a sleeve and a retainer.
